(19) United States
(12) Patent Application Publication
(10) Pub. No.: US 2006/0115264 A1
(43) Pub. Date: Jun. 1, 2006

(54) Forensic light and photography support

(76) Inventors: Nicolas Vezard, Edison, NJ (US); Gregoire Verrier, Metuchen, NJ (US)

Correspondence Address: ROGER PITT;KIRKPATRICK & LOCKHART NICHOLSON GRAHAM LLP, 599 LEXINGTON AVENUE, 33RD FLOOR, NEW YORK, NY, 10022-6030, US

(21) Appl. No.: 11/232,810

(22) Filed: Sep. 21, 2005

Related U.S. Application Data
(60) Provisional application No. 60/611,772, filed on Sep. 21, 2004.

(51) Int. Cl. G03B 17/00

(52) U.S. Cl. 396/419

(57) ABSTRACT

A method of photographing forensic evidence comprising the placing a frame on a stable surface is disclosed. An item of evidence is placed on the frame frame, followed by adjusting the position of said item of evidence; mounting a light source to said frame; adjusting the position of said light source; mounting a camera on said frame; adjusting the position of said camera; and actuating said camera to take a photograph.

### CROSS-REFERENCE TO RELATED APPLICATIONS

This application claims benefit of provisional application Ser. No. 60/611,772, filed Sep. 21, 2004 directed to FORENSIC LIGHT AND PHOTOGRAPHY SUPPORT, the priority of which is hereby claimed.

### STATEMENT REGARDING FEDERALLY SPONSORED RESEARCH OR DEVELOPMENT

(Not applicable.)

### TECHNICAL FIELD

The present invention relates to support devices for supporting cameras and light sources for forensic examination.

### BACKGROUND OF THE INVENTION

The use of various types of light sources for illuminating evidence is widespread. Typically, evidence is placed on a support surface and photography performed using a hand-held camera or tripod. At the same time, a forensic light source, generally hand-held, it is used to illuminate the evidence at an angle and with a wavelength of light which is calculated to achieve a desired photographic result. Typically, filters are used in connection with the camera, and filters may be used in connection with the light source.

### SUMMARY OF THE INVENTION

In one aspect, the invention provides a method for photographing forensic evidence which comprises the steps of placing a frame on a stable surface; placing the item of evidence on the frame; adjusting the position of the item of evidence; mounting a light source to the frame; adjusting the position of the light source; mounting a camera on the frame; adjusting the position of the camera; and actuating the camera to take a photograph.

Pursuant to one embodiment of the invention, forensic evidence is photographed, and the positions of the camera and/or the light source are varied relative to the evidence. Multiple pictures can be taken at various relative positions.

Desirably, the forensic evidence is photographed, and the positions of the camera and/or light source are varied by motors under computer control.

In a further aspect, the invention provides a forensic photography stand, which comprises a support base; a first track defined on the support base; a vertical support member riding on the first track; an evidence support track defined on the support base; an evidence support member which rides on the evidence support track whereby the position of the evidence may be varied; light source support brackets mounted on the vertical support member; a camera support bracket mounted on the vertical support member whereby the position of the camera and the vertical support member may be varied.

### BRIEF DESCRIPTION OF THE DRAWINGS

The invention may be understood from the following drawings, in which:

FIGS. 1-4 illustrate one embodiment of the inventive stand; and

FIGS. 6 and 7 illustrate alternative options for supporting evidence in the inventive stand.

### DETAILED DESCRIPTION OF THE PREFERRED EMBODIMENT

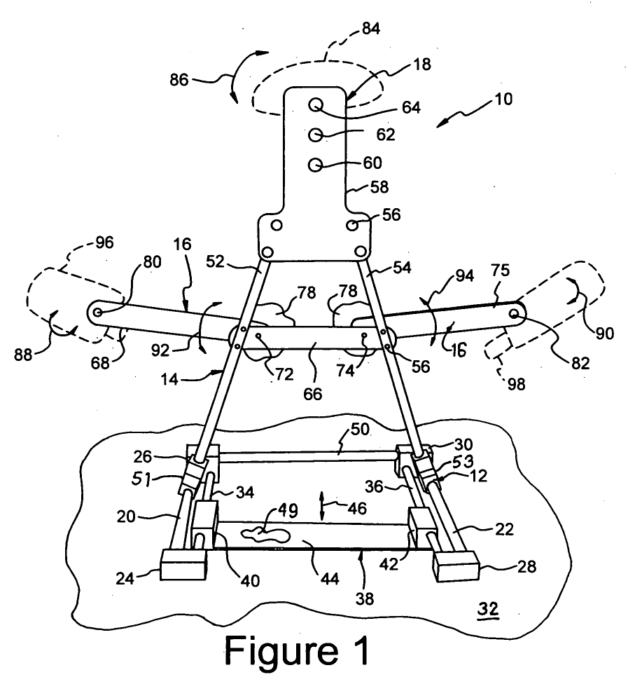

Referring to FIG. 1, a forensic light and photography support 10 is illustrated. Support 10 comprises a base section 12, a vertical section 14 secured to base section 12, a light support section 16 secured at the sides of vertical section 14, and a camera support section 18 secured to the top of vertical section 14. Either or both light support sections may be used to support one or more light sources.

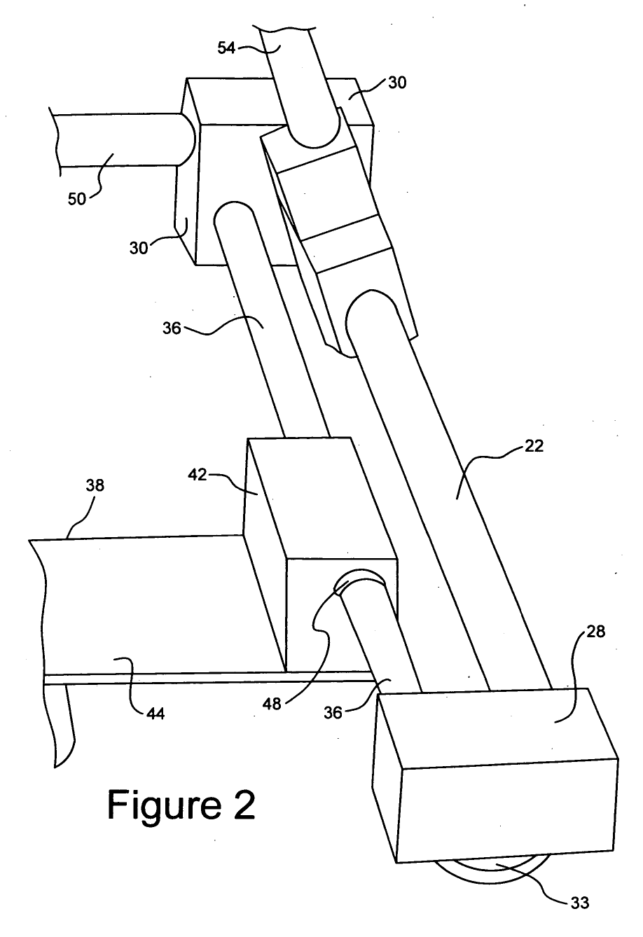

Base 12 comprises a pair of longitudinal support members 20 and 22, which are securely joined to foot supports 24, 26, 28 and 30, for example by using threads on the ends of members 20 and 22, friction fitted pins, bolts or the like. Foot supports 24-30 rest on a support surface 32. Each of the foot supports 24-30 has a rubber foot 33 secured to its bottom, as illustrated most clearly in FIG. 2. Foot supports 24-30 may be made from any suitable material, such as metal, metal alloy, or a suitably rigid and durable polymer plastic material.

A first longitudinal rail 34 is secured between foot supports 24 and 26. A second longitudinal rail 36 is secured between foot supports 28 and 30. A trolley 38, riding on a pair of blocks 40 and 42 comprises supporting a platen 44. Trolley 38 rides on rails 34 and 36, moving in the directions indicated by arrows 46 to rest in any desired position. Trolley 38 is mounted to frictionly and slidingly engage longitudinal rail 34 and 36 thus allowing it to be moved into any position and rest there unless sufficient force is applied to move it out of position. Alternatively, if desired, set screws may be provided with large knobs to lock the same in position.

Blocks 40 and 42 have holes 48 drilled in them. Holes 48 receive and conformingly engage rails 34 and 36, allowing trolley 38 to slide in the directions indicated by arrows 46.

Platen 44 supports evidence 49 to be photographed. In accordance with a preferred embodiment of the invention, a scale indicating length may be engraved in the platen 44 in order to provide a reference for the photography of evidence 49 resting on platen 44.

Base section 12 is made rigid (to adjust the position of the light source) by a transverse support member 50 which is rigidly secured to foot supports 26 and 30. Such securement may be implemented through the use of set screws, rivets, friction-fitted pins, or the like.

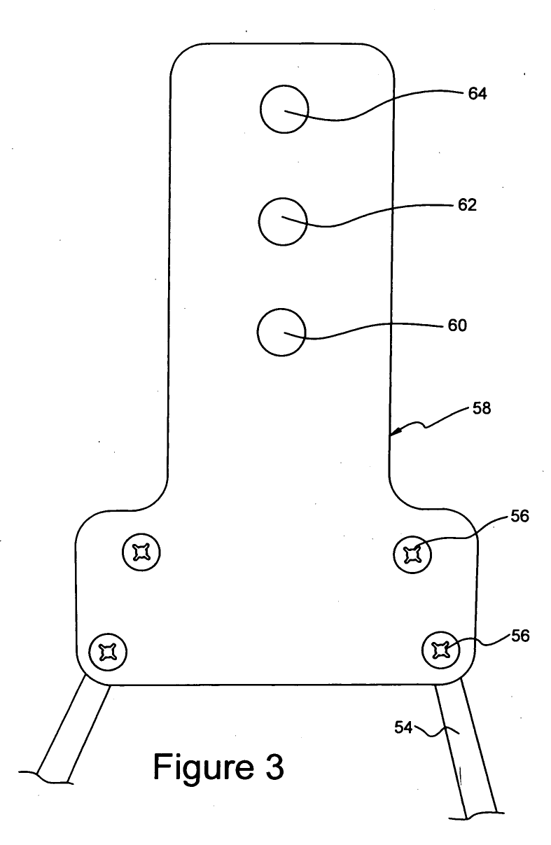

A pair of a vertically extending support rods 52 and 54 are secured to supports 51 and 53, respectively which slide with a minimal amount of friction due to slight lubrication on longitudinal support members 20 and 22. Supports 51 and 53 may be secured in place by a wing bolt or the like. Vertically extending support rods 52 and 54 are, in turn, secured by four screws 56 or friction fitted pins, or the like to a camera support plate 58 as illustrated in FIG. 3. Camera support plate 58 includes three support holes 60, 62 and 64. The use of a pair of screws on each of the vertically extending support rods 52 and 54 contributes to the rigidity of the system.

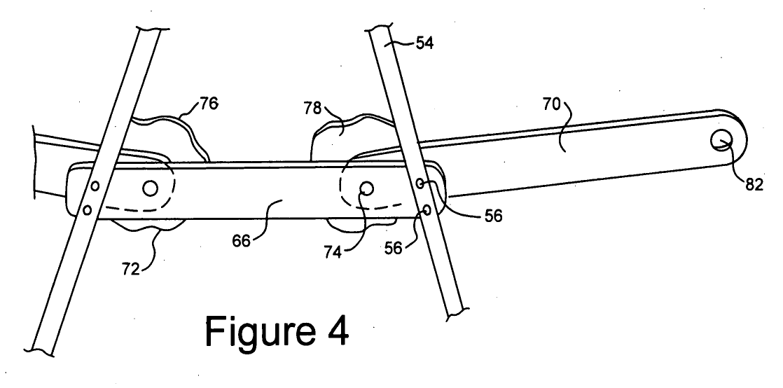

Forensic light source support section 16 comprises a support crossbar 66 (FIG. 1) which may be secured by a pair of screws to vertically extending support rods 52 and 54. A pair of arms 68 and 70 (FIG. 4) are, in turn, secured to support crossbar 66 by tightening bolts 72 and 74. Tightening bolts 72 and 74 terminate in large plastic knobs 76 and 78, respectively allowing them to easily be tightened. If desired, lock watchers may be used, or suitable mechanical serrations or the like included in the arms and/or support crossbar 66. Tightening bolts 72 and 74 extend through holes in arms 68 and 70. Tightening bolts 72 and 74 are threaded to matingly engage tapped holes in support crossbar 66, as illustrated most clearly in FIG. 4. The ends of arms 68 and 70 terminate, respectively, in holes 80 and 82.

Holes 60, 62, 64, 80 and 82 may be provided with tightening bolts of the type typically found on camera tripods. This enables the stand to be used to secure a camera, or a forensic light source provided with a tapped hole type camera mounting.

When it is desired to use the inventive system, a camera 84 may be mounted on camera support plate 58 using any one of holes 60, 62 or 64, in the manner conventional by employed with camera tripods. Evidence 49 may be placed on platen 44 and the position adjusted in the directions indicated by arrows 46.

For example, camera 84, (which may include an image intensifying lens) may be positioned in hole 64 for the purpose of taking a photograph of evidence 49 located on platen 44. If one wishes to obtain a slightly larger picture, camera 84 may be placed in hole 60 or 62.

In connection with this, it is noted that the angular position of camera 84 and the light sources may be varied in the directions indicated by arrows 86, 88 and 90. Likewise, camera 84 may be mounted on an arm of any of the type described in this specification for the purpose of varying its position and angle, thus providing flexibility for the photography of images which may benefit from varying positions and angles of attitude for the camera and illumination, as more fully appears below.

More particularly, one or two forensic light sources may be mounted in either of holes 80 and 82, with their angles varied by rotation in the directions indicated, respectively, by arrows 88 and 90.

Such adjustment in the directions indicated by arrows 88 and 90 and further adjustment of arms 68 and 70 in the directions indicated by arrows 92 and 94 provides a wide range of flexibility in the adjustment of the angle of illumination of light output from a forensic light source, such as forensic light sources 96 and 98 mounted in holes 80 and/or 82. In accordance with the invention, the position of the arms, the angular position of the light sources and the position on the camera may be maintained by tightening the respective knob associated with the source and/or camera which one wishes to secure in place.

In accordance with an alternative embodiment the invention, arms 68 and 70 may be replaced by articulated arms, such as articulated arm 168, as illustrated in FIG. 5, for the purpose of varying angle and distance (and thus illumination intensity). Articulated arm 168 includes a pair of arm members 169 and 171, which are secured to each other by a threaded pin 173 which is tightened by and integral with a knob 175. Pin 173 is threaded and matingly engages a tapped hole 177 in arm 169.

It is noted that while knob and tapped hole securements are illustrated in FIGS. 1-5, any suitable securement may be used, such as a ball and socket. Alternatively, malleable wires may be used in place of the illustrated arms, or arms 68 and 70 may be replaced by a spiral interlocking structure (or “gooseneck”) of the type used to secure the position of reading lamps. Ball and socket joints may be used to attach camera and/or light sources.

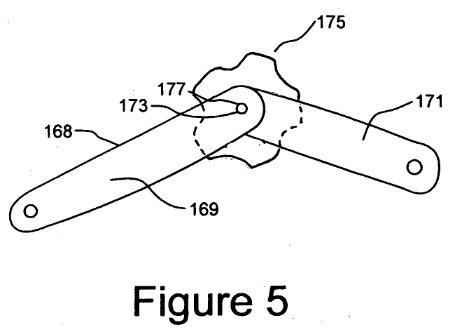

Likewise, in accordance with an alternative embodiment of the invention, trolley 38 may be replaced by a rotatably mounted platen 238, as illustrated in FIG. 6.

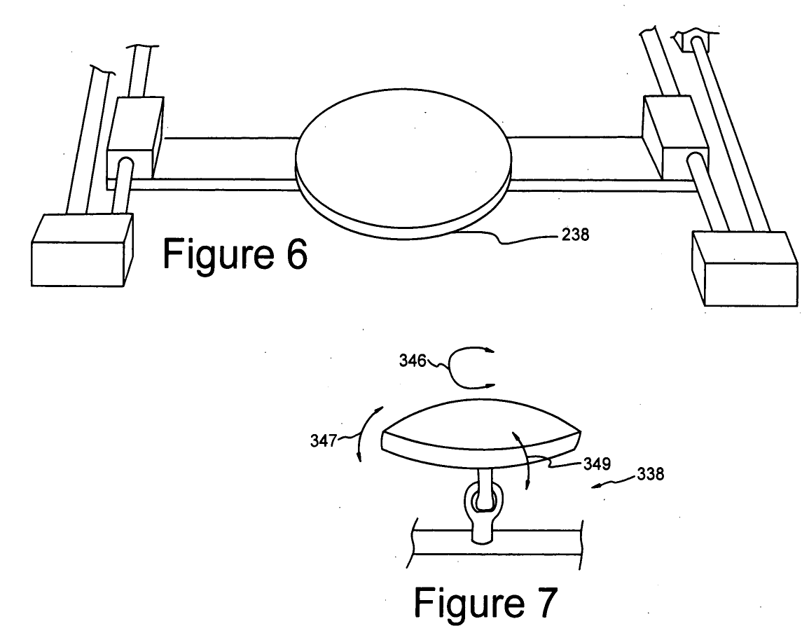

In accordance with a further alternative embodiment of the invention, a circular platen of the type illustrated in FIG. 6 may be mounted on a ball and socket support 338, as illustrated in FIG. 7. This allows complete freedom in the placement of and orientation of a specimen being illuminated, such as a sample of a fingerprint, blood stain, questioned document, or the like. For example, such specimen may be rotated in the directions indicated by arrows 346, and 347, as well as the direction indicated by arrows 349 which are in a plane perpendicular to the plane defined by arrows 347.

Still yet another alternative is the use of a telescopic member for supporting a specimen of evidence, or the light sources or camera.

In accordance with yet another alternative of the invention, arms 68 and 70 illustrated in FIG. 1 may have a linkage mechanism which causes holes 80 and 82 to define a line parallel to the support surface defined by foot supports 24-30.

In accordance with the present invention, movement of the trolley, or any of the other specimen support surfaces, as well as the motion of the arms and position of the camera support may be motorized and, for example, computer-controlled. In accordance with a particularly preferred embodiment of the invention, a computer may be programmed to execute the photography of a specimen using a preselected set of camera positions, camera orientations, light source positions, light source orientations, and/or other variables in order to automatically produce a wide variety of images under different conditions.

Such images may, further, be submitted to automatic computerized image analysis in order to amalgamate features which are viewable under various conditions. Such amalgamation would entail the normalization of views taken from different distances, at various angles, and with lenses of various focal lengths to a standard image. Artificial intelligence software may be used to identify features, map their locations and assemble a composite or amalgamated image. Because such multiple imaging is performed using a computer, it is cost effective and a large number of images may be obtained and integrated in this matter.

In addition, the variables associated with a computerized imaging sequence may include illumination wavelength, the introduction of filters to filter the output of the forensic light sources, and the introduction of filters to filter the light input into the camera.

In accordance with the invention, it is contemplated that the inventive system may be used in conjunction with digital cameras, as well as with photographic film cameras. In the case of using a film camera, the developed image may be push-processed or otherwise processed to bring out desired features. Likewise, chemically developed images may be scanned into PDF or other suitable image format for use by the computer in a mapping process.

In accordance with yet another embodiment of the invention, plate 58 may be replaced by an articulated member or a rail or rails secured to a support plate.

Preferably, the inventive device is painted with a flat black paint or other similar finish, in order to reduce reflection.

The base consists of 4 poles parallel to each other. Each set of poles form a track. An inner track 24, which slides and adjusts the evidence tray 20 and an outer track 22, which slides and adjusts the A-arm support 14.

The inventive stand 10 may be used to support a scope, camera, or viewer. Stand 10 may also include an adjustable vertically oriented slider, or track, on which a scope, camera, or viewer can be mounted. This allows the user to vary the distance from the evidence. The fixed position can be varied and sit at an up/down position fixed on y-axis.

Grooved surfaces may be provided on the various knobs (e.g. knob 78) and the surfaces on which they bear in order to have the position more stably fixed. The UV light source is mounted on the ends of the arms in order to provide a light source for the evidence at the base.

Either one or two UV or thin light sources can be used. Both can be adjusted at different heights or a leveler device may be used to keep the arms at the same height on both sides. This allows the cameras to be set at equal heights, while allowing their angles to be adjusted.

As noted above, the base has a plurality of guide rails. One pair of guide rails provides a track for the scope and the UV light source.

The braces and guide rails serve dual purposes. It supports the main structure of the embodiment and it also guides the arms and evidence.

The slide guides also hold the A-arm, are guided on the poles of the base, which have slight lubrication. The slide guides also may have a screw in order to keep the position desired by the operator. The screws can be the knob type or butterfly head in order to be easy to adjust.

If desired, separate vertical supports may be used for the light sources and for the camera resulting in a pair of A-frame shaped supports for the light sources and the camera, allowing separate adjustment of the position of both camera and light sources.

While illustrative embodiments of the invention have been described above, it is, of course, understood that various modifications will be apparent to those of ordinary skill in the art. Many such modifications are contemplated as being within the spirit and scope of the invention.

1. A method of photographing forensic evidence comprising the steps of placing a frame on a stable surface; placing item of evidence on said frame; adjusting the position of said item of evidence; mounting a light source to said frame; adjusting the position of said light source; mounting a camera on said frame; adjusting the position of said camera; and actuating said camera to take a photograph.

2. A method of photographing forensic evidence as in claim 1, where in the positions of the camera and/or the light source are varied relative to the evidence and multiple pictures are taken at various relative positions.

3. A method of photographing forensic evidence as in claim 2, wherein said positions are varied by motors under computer control.

4. A forensic photography stand, comprising a support base; a first track defined on said support base; a vertical support member riding on said first track; and evidence support track defined on said support base; an evidence support member in riding on said evidence support track whereby the position of said evidence may be varied; light source support brackets mounted on said vertical support member; a camera support bracket mounted on said vertical support member whereby the position of the camera and the vertical support member may be varied.
